(19) United States
(12) Patent Application Publication
(10) Pub. No.: US 2016/0266277 A1
(43) Pub. Date: Sep. 15, 2016

(54) CONTINUOUS SENSOR MEASUREMENT IN HARSH ENVIRONMENTS

(71) Applicant: FMC TECHNOLOGIES, INC., Houston, TX (US)

(72) Inventors: T. Joel Blackburn, Houston, TX (US); Mitchell K. Knaub, Houston, TX (US); Matthew S. Triche, Houston, TX (US); L. Lane Sanford, Houston, TX (US); Eric J. Snell, Houston, TX (US); Mahlon Lisk, Houston, TX (US); Levi Honeker, Houston, TX (US)

(73) Assignee: FMC Technologies, Inc., Houston, TX (US)

(21) Appl. No.: 15/034,478

(22) PCT Filed: Nov. 5, 2014
(86) PCT No.: PCT/US2014/064061

§ 371 Date: May 4, 2016

Related U.S. Application Data
(60) Provisional application No. 61/900,664, filed on Nov. 6, 2013.

(51) Int. Cl. G01V 11/00; G01K 7/36; G01L 9/00; G01V 9/00

(52) U.S. Cl. CPC G01V 11/002; G01V 9/005; G01K 7/36; G01L 9/007

(57) ABSTRACT

A sensor module may be formed including a core of ferromagnetic material associated with a wire coil forming a passive inductor resonant circuit, which may be used in temperature sensor modules and pressure sensor modules suitable for use in high temperature, high pressure, and corrosive environments. The passive inductor resonant circuits of the sensors may be tuned such that its resonant frequency is in a bounded frequency band interrogable with an electromagnetic energy signal having a frequency of less than or equal to about 10 MHz. Such sensors may be disposed in series in a sensor array, interrogable with an interrogation module, where the interrogation module may demultiplex, the frequencies of the multiple sensors to determine the environmental conditions sensed by the individual sensors.

### FIELD OF THE DISCLOSURE

Embodiments disclosed herein relate generally to sensors and sensor systems that may be used in harsh environments, such as a high temperature, high pressure, corrosive environment that may exist within wellbores during extraction of oil and gas.

### BACKGROUND

In oil and gas extraction processes there is a need to monitor pressure and temperature. The environment in which monitoring systems must operate is very harsh; high temperature, high pressure, and corrosive environments typically exist simultaneously.

Given the current state of the art, the practical maximum operating temperature of even specialized high temperature active electronics is about 220° C. As a result, long distance wired sensor networks, which are conventionally constructed using active electronics, can only be practically deployed in environments where ambient temperatures do not rise above 220° C.

To avoid the temperature limitations of active electronics, passive optics have been employed. These offer the advantage of being constructed from glass and other transparent materials which tolerate higher temperatures than doped semiconductors. To communicate with interrogator modules at the surface, installations which employ passive optics rely on fiber optic cable. For example, U.S. Pat. No. 7,636,052 describes a system which interrogates resonant sensor modules with electromagnetic energy through a coaxial cable.

However, a primary disadvantage of passive optics is their fragility. Compared to electrically conductive metallic cabling, fiber optic cables are very vulnerable to shock and vibration. In certain applications, such as those involving hydraulic fracturing of wells, fiber optic cables are known to have a high rate of failure.

One common practice for remote temperature monitoring involves the use of thermocouples. These devices provide a relatively reliable means of measuring temperatures in harsh environments. However, thermocouples present practical challenges to taking measurements at many different points in a system. For example, such downhole temperature measurement systems often depend on the inclusion of active electronics for signal processing at the point of measurement. As discussed above, even the most specialized circuitry will not reliably operate above 220° C., and to overcome the temperature limits of active electronics, most downhole measurements of extreme temperatures utilize fiber optic measurement systems. While capable of extreme temperature measurements, fiber optic systems are fragile and suffer from poor reliability in downhole environments.

Various methods of passively sensing temperature by detecting changes in the amplitude of a signal have been proposed. For example, thermocouples utilize a changing voltage at the junction of dissimilar metals. Also, resistance thermal detectors (RTDs) can be used to vary the amplitude of a signal through changing resistance within an electrical circuit. In the case of thermocouples and RTDs remote detection a long distance from the signal processing device can have technical barriers due to environmentally induced noise and/or practical concerns with installation complexity due to individual conductors being required for each temperature measurement point.

Others have proposed utilization of temperature dependent changes of inductance as a means of temperature threshold measurement. These applications utilize the Curie temperature of a ferromagnetic material as a means of detecting a temperature threshold. The Curie temperature is known as the temperature at which a material abruptly loses its ferromagnetic properties. By selecting a material with a Curie temperature at a desired threshold level, a system can be constructed which can detect temperature excursions around this threshold.

US20110180624 describes a method of threshold detection where two different inductors are constructed with two different ferromagnetic core materials having rates of permeability change with respect to temperature. The windings of the two inductors are designed such that the inductance of each is equal at a certain temperature threshold.

There exists within the oil and gas industry, pressure sensing elements which can measure very high pressure. However, the operational temperature limits of the pressure measurement devices available in the industry are below the temperature in many common oil and gas wells. In many cases, the temperature limitation is the result of the need to have active electronics located in close proximity to the pressure transducer. In cases where active electronics are not the limiting factor for high temperature, the limit is related to the physical construction of the pressure transducer, such as a bonded foil construction on a strain gauge.

U.S. Pat. No. 7,841,234 describes an apparatus for sensing pressure in which the magnetic properties of an elastomeric suspension of ferromagnetic material change in response to pressure. This patent describes an apparatus for sensing pressure in which the inductance of a coil changes in response to pressure compressing the physical length of a coil.

### SUMMARY OF THE DISCLOSURE

Embodiments disclosed herein provide temperature and pressure sensors that may be highly reliable under the harsh conditions that may be experienced during oil and gas drilling and extraction processes. Such devices may also be of simple, low-cost construction, and may be fully passive in its operation.

In one aspect, embodiments disclosed herein relate to a sensor module including a core of ferromagnetic material associated with a wire coil forming a passive inductor resonant circuit. The passive inductor resonant circuit is tuned such that its resonant frequency is in a bounded frequency hand interrogable with an electromagnetic energy signal having a frequency of less than or equal to about 10 MHz.

In another aspect, embodiments disclosed herein relate to a temperature sensor module including a housing and a temperature sensor disposed within the housing. The temperature sensor may include a core of ferromagnetic material associated with a wire coil forming a passive inductor resonant circuit, an inductance of which varies with temperature. The passive inductor resonant circuit is tuned such that its resonant frequency is in a bounded frequency band interrogable with an electromagnetic energy signal having a frequency of less than or equal to about 10 MHz.

In another aspect, embodiments disclosed herein relate to a pressure sensor module including a core, including a fixed core portion and a deflectable core portion, comprising a ferromagnetic material associated with a wire coil forming a passive inductor resonant circuit. A gap is formed between at least a portion of the fixed core portion and an internal surface of the deflectable core portion. A pressure applied to an outer surface of the deflectable core portion deflects the deflectable core portion, decreasing a length of the gap and affecting an inductance of the resonant circuit.

In another aspect, embodiments disclosed herein relate to a sensor array including two or more sensor modules comprising a sensor comprising a solid core of ferromagnetic material associated with a wire coil forming a passive inductor resonant circuit. Each sensor in the array is tuned such that its resonant frequency is in a bounded and unique frequency band, separate and not overlapping with a frequency band of another sensor module disposed in the array.

In another aspect, embodiments disclosed herein relate to a system for measuring properties of a wellbore, such as temperature and/or pressure. The system may include: a sensor module comprising a sensor comprising a solid core of ferromagnetic material associated with a wire coil forming a passive inductor resonant circuit; an interrogation module having an excitation port configured to provide electrical excitation to the passive inductor resonant circuit, and a sensor port configured to receive a transmitted response to the electrical excitation; a transmission line for transmitting the electrical excitation from the excitation port to the passive inductor resonant circuit; and a transmission line for transmitting the response to the electrical excitation from the passive inductor resonant circuit to the sensor port.

In another aspect, embodiments disclosed herein relate to a process for measuring a property in a wellbore. The process may include: disposing in a wellbore a sensor module or a sensor module array comprising at least one sensor comprising a solid core of ferromagnetic material associated with a wire coil forming a passive inductor resonant circuit; interrogating the at least one sensor with an electromagnetic energy signal having a frequency of less than or equal to about 10 MHz; measuring a response from the sensor comprising a change in frequency of the electromagnetic energy signal; and determining a value of the measured property as a function of the change in frequency of the electromagnetic energy signal.

Other aspects and advantages will be apparent from the following description and the appended claims.

### BRIEF DESCRIPTION OF DRAWINGS

FIG. 1 is a perspective view of a passive inductor resonant circuit, such as may be used in a temperature sensor according to embodiments herein.

FIG. 2 is a perspective view of a passive inductor resonant circuit, such as may be used in a pressure sensor according to embodiments herein.

FIG. 3 is a cross-sectional view of a pressure sensor module according to embodiments herein.

FIG. 4 is a simplified block diagram of a property measurement system according to embodiments herein.

FIG. 5 is a simplified block diagram of a property measurement system according to embodiments herein.

FIG. 6 illustrates a property measurement system according to embodiments herein as may be used when measuring properties of a wellbore.

### DETAILED DESCRIPTION

Embodiments disclosed herein provide a sensor module, which may be used alone or as part of a sensor array. The sensor is designed for use in harsh environments, which as used herein, is defined as temperatures in excess of 220° C., pressures greater than 100 psig, and/or that may result in contact with corrosive chemical compounds. The sensors may include a core of magnetic material associated with a wire coil, forming a passive inductor resonant circuit.

The magnetic core may include, for example, materials that have a relative magnetic permeability of greater than about 1000. The magnetic core may be formed from materials that are of a ferromagnetic composition. In some embodiments, the ferromagnetic material may include 3C90 Ferrite. In other embodiments, the core may be formed from material compositions useful to induce changes in inductance of the passive inductor resonant circuit. For example, a non-magnetic, highly conductive material can be used to form at least a portion of the core. The core may be of any variety of shapes. For example, the core may be cylindrical, disc-shaped, doughnut-shaped, or other number of shapes as known to those skilled in the art. The core may be held in position within the sensor by a suitable non-conducting structure.

The wire coils may be formed from a conductive material, wrapped around the core. In some embodiments, the wire coils may be formed from magnet wire, 1 hr example, such as 22 AWG magnet wire. The wire may be wound around the core one or more times, such as from 5 to 50 times or more. In some embodiments, the coil may be a toroid comprising 20 to 50 turns of magnet wire around a core.

The passive inductor resonant circuit may be tuned such that its resonant frequency is in a bounded frequency band interrogable with an electromagnetic energy signal having a frequency of less than or equal to about 10 MHz. For example, transmission lines may provide electrical excitation to the passive circuit elements within a sensor module. Depending upon the sensible condition in which the sensor is subjected, the passive inductor resonant circuit may alter a frequency of the electromagnetic energy signal. Sensor measurements may then be derived, from this response.

Sensors described herein include passive circuit elements that may be thrilled using robust metallic cabling. Sensors described herein may thus avoid the inherent fragility of passive optics and the temperature limitations imposed by the active electronics, improving the reliability of the sensors, even when used in a harsh environment, which may include high temperatures, high pressures, and contact with corrosive compounds.

Sensors described herein may be used in systems for measuring and/or monitoring temperature and pressure. For example, the sensors may be deployed in as wellbore to measure the temperature at one or more locations within the wellbore. The sensors may also be used in a sensor array, where two or more sensors, including one or more temperature sensors and/or one or more pressure sensors, may be electrically coupled in series via discrete sections of transmission line. Each sensor in the sensor array may be tuned such that its resonant frequency is in a bounded and unique frequency band, separate and not overlapping with a frequency band of another sensor module disposed in the array. In this manner, an interrogation module may be used to analyze how the sensors in the sensor array may respond to varying frequencies of excitation. The unique tuning band of each sensor provides a mechanism to demultiplex the response of the sensors.

While sensors and their use in have been generically described above, temperature sensors, pressure sensors, sensor arrays including such temperature and/or pressure sensors, systems for using such sensors, as well as methods for using such sensors will be elaborated upon in the sections below.

Temperature Sensor Modules

Temperature sensor modules according to embodiments herein may include a housing, and a temperature sensor disposed within the housing. The housing may be formed of conductive materials, non-conductive materials, or both, where the sensor is electrically isolated from the housing. Examples of nonconductive materials or substances that may be used to form housings or barriers in embodiments herein include plastics, elastomers and various insulation materials. For example, a plastic harrier may include a plastic waterproof housing formed from a thermoplastic material having an ultra-high melting point. The sensor may be positioned in the plastic housing, which may be mounted to, for example, a subsea component to be placed within a wellbore. An example of an insulation harrier is a layer of epoxy or polymer resin which may be applied to a subsea component, for example. In this example, the sensor may be mounted on the subsea component under the insulation layer. In other embodiments, a metallic housing may be used, and the sensor may be disposed within the metallic housing, electrically isolated from the housing such as by the plastic, elastomeric or insulation materials.

The temperature sensor may include a core of ferromagnetic material associated with a wire coil forming a passive inductor resonant circuit. The inductance of the passive inductor resonant circuit may vary with temperature. As noted above, the passive inductor resonant circuit may be tuned such that its resonant frequency is in a bounded frequency hand interrogable with an electromagnetic energy signal having a frequency of less than or equal to about 10 MHz.

While the temperature dependent nature of ferromagnetic materials (specifically, the behavior around the Curie temperature), have regularly been used for threshold temperature detection, embodiments herein utilize changing permeability of ferromagnetic materials, or assemblies, below the Curie temperature as a means of measuring absolute temperature.

Two embodiments are described herein, including, a first embodiment where a solid core of ferromagnetic material is used with a coil of wire to form an inductor, and a second embodiment where a closed-core geometry of ferromagnetic material is constructed with a gap perpendicular to the magnetic flux path.

In the first embodiment, three different physical characteristics of the ferromagnetic core, including cross sectional area, mean magnetic path length, and relative permeability, can vary with temperature. The core of ferromagnetic material may include a solid core of ferromagnetic material having a closed geometry. The wire coil may be disposed around at least a portion of the solid core. The inductance of the passive inductor resonant circuit formed from a solid, core may vary with temperature, and the inductance (L) of the passive inductor resonant circuit formed may follow the equation:

$$L = \frac{{N}^{2} {μ}_{r} {μ}_{o} A}{{l}_{m}}$$

where N=number of turns of the coil of wire, A=cross sectional area of the ferromagnetic core material, lₘ=mean magnetic path length through the core, μᵣ=relative permeability of the ferromagnetic core material, and μₒ=permeability of free space. Each of A, lₘ, and μᵣ may vary as a function of temperature.

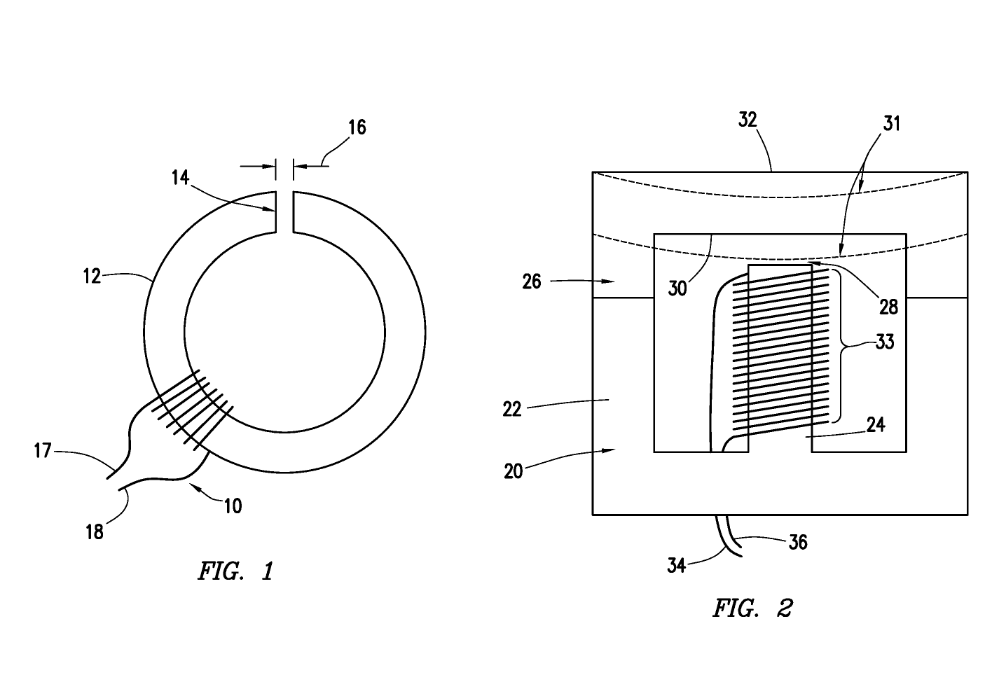

In the second embodiment, core of ferromagnetic material may include a ferromagnetic material having a closed-core geometry and including a gap in the ferromagnetic material perpendicular to the magnetic flux path. In some embodiments, the core material includes two different materials, a primary magnetic core material and a gap material. The core material is selected with a coefficient of thermal expansion sufficient to significantly vary the gap distance as a function of temperature change. As illustrated in FIG. 1, an inductor is formed with a coil of wire (inductor windings 10) around core 12, which includes a gap 14. The varying length 16 of gap 14, due to temperature changes, alters the inductance of the assembly by changing the effective permeability of the core. The inductance of the passive inductor resonant circuit formed from the closed-core may thus vary with temperature, and the inductance (L) of the passive inductor resonant circuit formed may follow the equation:

$$L = \frac{{N}^{2} A}{\frac{{l}_{m}}{{μ}_{r 1} {μ}_{o}} + \frac{{l}_{g}}{{μ}_{r 2} {μ}_{o}}}$$

where N=number of turns of the coil of wire, A=cross sectional area of the ferromagnetic core material, lₘ=mean magnetic path length through the core, μᵣ₁=relative permeability of the ferromagnetic core material, μₒ=permeability of free space, l_{g}=length of the gap, and μᵣ₂=relative permeability of material in the gap.

Each of A, lₘ, l_{g}, and μᵣ₁ may vary as a function of temperature. The length of the gap may thus depend on the thermal coefficient of expansion of the core material as well as the overall geometry of the core. The passive inductor resonant circuit may be designed such that the inductance of the passive inductor resonant circuit is primarily a function, of a length of the gap. For example, if μr2 is substantially smaller than μr1, it can be seen that small changes in lg can result in large changes in L. If an inductor is constructed of wires wound around a closed-core geometry (e.g. a toroid) with a small air gap perpendicular to the magnetic flux path, the inductance of the assembly would change with temperature as thermal expansion of the core material causes growth along the centerline and reduces the length of the gap. In the case of a toroid, there would also be some circumferential growth, which would cause some decrease in inductance due to expansion of the mean magnetic path length (lm). However, the decrease in the gap length (lg) will cause a significantly larger positive change in inductance, provided μr2 is substantially greater than μr1. In some embodiments a ratio of μᵣ₂ to μᵣ₁ is at least 20:1, such as at least 50:1 or 100:1 in some embodiments.

Temperature sensors modules according to embodiments herein may be useful for measuring temperatures in harsh environments; including temperatures in excess of 220° C. In some embodiments, the temperature sensor is configured to measure a temperature range, such as a range having a maximum temperature below a Curie temperature of the core and the range inclusive of a temperature of at least 220° C. For example, temperature sensors herein may be useful for measuring temperature over a range, where the temperature range that may be measured may have a lower limit in the range from less than 0° C. to about 300° C. and an upper limit in the range from about 230° C. to about 750° C.

The temperature sensor module, such as illustrated in FIG. 1, may further include a first lead 17 configured to receive an electromagnetic energy signal from a source, as well as a second lead 18 configured to transmit a response to the electromagnetic energy signal to a sensing device, which may measure a change in the frequency of the electromagnetic energy signal.

By utilizing the continuous change in ferromagnetic properties of the core of an inductor assembly below its Curie temperature, absolute temperature measurements can be made using temperature sensor modules according to embodiments herein, rather than just threshold temperature detection. Additionally, inclusion of a gap in a closed ferromagnetic core geometry may allow greater change in effective permeability over temperature than would be possible by just utilizing the natural change in permeability with respect to temperature of the primary core material, although both embodiments may be effective.

Temperature sensor modules according to embodiments herein utilize changing, magnetic properties, coupled with a resonant circuit, to create a change in frequency with respect to temperature. This has the advantage of much higher noise immunity compared with the common methods of correlating signal amplitude to temperature. Temperature sensor modules herein may be constructed of materials which can operate effectively in extreme temperatures, whereas prior art solutions have temperature limitations due to material degradation andior unacceptable performance drift due to component aging. Further, temperature sensors herein, as well as the supporting hardware, may be constructed of materials that are much more robust than conventional fiber optic measurement systems. The temperature sensor module can be constructed of simple metal alloys or exotic ferromagnetic materials, depending on the desired tradeoffs of performance and cost. The temperature sensor module can be constructed such that there will be little or no degradation of performance over time due to component aging or fatigue, even when located within the harsh environment. A gapped, closed-core geometry can allow a very large change in inductance versus temperature, advantageously allowing a high resolution measurement system.

Pressure Sensor Modules

Temperature sensor modules according to embodiments herein may include a core, including a fixed core portion and a deflectable core portion. At least one of the fixed core and the deflectable core portions include a ferromagnetic material associated with a wire coil forming a passive inductor resonant circuit. A gap is formed between at least a portion of the fixed core portion and an internal surface of the deflectable core portion. A pressure applied, to an outer surface of the deflectable core portion deflects the deflectable core portion, decreasing a length of the gap and affecting an inductance of the resonant circuit.

Referring now to FIG. 2, a simplified depiction of a pressure sensor inductor assembly, including a gapped magnetic core, according to embodiments herein, is illustrated. The sensor inductor assembly may include a fixed position core 20, which may include an outer portion 22 and a rod portion 24, and a variable position core 26. The bulk of the core may be formed from a ferromagnetic material with substantially higher relative permeability than air. The core is constructed such that a gap 28 is formed between a top of the rod portion 24 and an inner surface 30 of the variable position core 26. The core is constructed such that a length of the gap will change with applied pressure. For example, the variable position core 26 may be directly or indirectly deflected inward, such as illustrated by dotted lines 31, based on an applied pressure to an outer surface 32 of the variable position core 26.

A wire coil 33 may be wrapped around rod portion 24, forming a passive inductor resonant circuit. Similar to the temperature sensor described above, the passive inductor resonant circuit may be tuned such that its resonant frequency is in a bounded frequency band interrogable with an electromagnetic energy signal having a frequency of less than or equal to about 10 MHz. The pressure sensor module may also include a first lead 34 configured to receive the electromagnetic energy signal and a second lead 36 configured to transmit a response to the electromagnetic energy signal.

The inductance (L) of the passive inductor resonant circuit of a pressure sensor module according to embodiments herein follows the equation:

$$L = \frac{{N}^{2} A}{\frac{{l}_{m}}{{μ}_{r 1} {μ}_{o}} + \frac{{l}_{g}}{{μ}_{r 2} {μ}_{o}}}$$

where N=number of turns of the coil of wire, A=cross sectional area of the ferromagnetic core material, lₘ=mean magnetic path length through the core, μᵣ₁=relative permeability of the ferromagnetic core material, μₒ=permeability of free space, l_{g}=length of the gap, and μᵣ₂=relative permeability of material in the gap.

The length of the gap, as described above, is a function of the relative deflection of the variable position core based on the applied pressure. The passive inductor resonant circuit may thus be designed such that the inductance of the passive inductor resonant circuit is primarily a function of a length of the gap. For example, if μr2 is substantially smaller than μr1, it can be seen that small changes in lg can result in large changes in L. In some embodiments a ratio of μᵣ₂ to μᵣ₁ is at least 20:1, such as at least 50:1 or 100:1 in some embodiments.

Pressure sensors according to embodiments herein may be designed to operate in harsh environments. For example, pressure sensor modules herein may be configured to measure a discrete pressure range when operating at a temperature below a Curie temperature of the core, which may include operating temperatures of at least 220° C. The thickness of the variable position core, the material of construction of the variable position core, and other design variables may be selected to provide a change in the gap distance, affecting inductance of the circuit, for measurement of pressure over a discrete range of pressures. Further, as the flexibility of the variable core material may vary with temperature, systems measuring a response of the circuit may include temperature as a variable when converting the response to a calculated pressure.

In some embodiments, the pressure sensor may be configured to measure a pressure range, wherein the range is inclusive of pressures greater than 100 psig (harsh environments). For example, pressure sensors according to embodiments herein may be configured to measure a pressure range, where the range to be measured may have a lower limit in the range from about atmospheric pressure to 1000 psig to an upper limit in the range from about 100 psig to about 5000 psig or higher. As noted above, the range of pressure that may be measured by a pressure sensor may depend upon the properties (material and physical) of the variable position tore well as the initial gap length (undeflected variable position core).

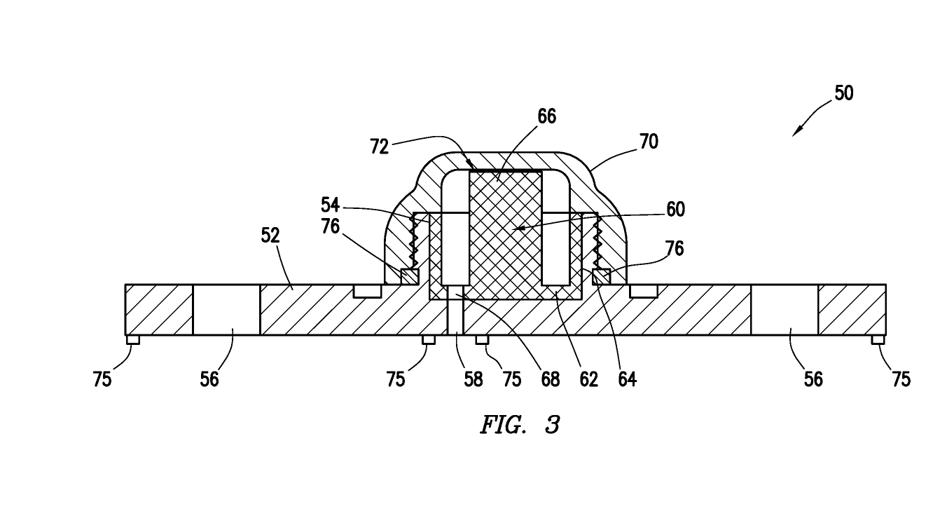

FIG. 3 is a cross-sectional view of an embodiment of a pressure sensor module according to embodiments herein. The pressure sensor module 50 may include a housing or base 52, which may include a recessed housing 54. The housing and base may be formed of conductive materials, non-conductive materials, or both, where the sensor is electrically isolated from the housing. Examples of nonconductive materials or substances that may be used to form housings or barriers in embodiments herein include plastics, elastomers and various insulation materials. Base 52 may also include one or more holes 56, which may be used to dispose the pressure sensor module on a subsea component to be placed within a wellbore, such as via screws or other attachment mechanisms. A hole 58 may also be provided through which the ends (leads) of the wire coils may be disposed.

A fixed position core 60 may be disposed within the recessed housing portion 54 of base 52. The fixed position core may include a bottom portion 62, side portions 64, and a central rod portion 66, which may be a contiguous construction in some embodiments. A hole 68 may be provided within bottom portion 62, and when aligned with hole 58 in the base, may provide for passage of the leads of the wire coil.

A variable position core 70 may be disposed over rod portion 66, providing a variable gap 72 between an inner surface of the variable position core 70 and a top of the rod portion 66. The inductor assembly, as illustrated in FIG. 3, may have a variable value of inductance with applied pressure, and may be combined with capacitor elements to form a resonant circuit. The frequency of this resonance can be determined by methods known by those skilled in the art, and the frequency of resonance can be directly correlated to the applied pressure. Those skilled in the art will also recognize that other methods of correlating inductance change to pressure are possible including, but not limited to direct measurement of the inductance.

The core materials may be of ferromagnetic composition. However, other material compositions can be used to induce changes in inductance. For example, a non-magnetic, highly conductive material can be used for the variable position core. In this case, the opposing magnetic field created by eddy currents in the variable position core would cause a change in inductance proportional to the gap length.

As noted above, the variable position core may be directly or indirectly deflected as a result of pressure in the environment to be sensed. For example, the variable position core may be isolated from the harsh environment and indirectly deflected by a piston, or other mechanical means, a position of which may be affected by the pressure in the environment to be sensed. In other embodiments, the pressure sensor module, such as that as illustrated in FIG. 3, may be disposed within the harsh environment. In such embodiments, the deflectable core portion may be formed from a material or coated with a material on an outer surface of the variable position core, where the material of selection or coating is suitable for use in corrosive environments.

As the pressure sensor module, such as that illustrated, in FIG. 3, may be disposed on a subsea component to be placed within a wellbore and exposed to harsh environments, it may be desirable to seal various portions of the sensor from the environment. For example, one or more seals 75 may be provided to sealingly engage the base to the subsea component, preventing gases, fluids, and/or solids in the environment from entering the sensor via holes 58, 68. Similarly, the variable position core 70 may be sealingly engaged with recessed housing portion 54, such as via seals 76. Variable position core 70 may be threadedly connected to recessed housing portion 54 in some embodiments, providing for removal of the variable position core 70 and fixed position core, as well as visual inspection or repair of the resonant circuit.

Other devices that use inductance changes to measure pressure rely on changing the geometry of the inductor windings or changing the permeability of the core material through application of pressure. Pressure sensors of embodiments herein use the variability of an air gap with applied pressure in the magnetic core as the mechanism to measure pressure. Pressure sensors according to embodiments herein may be constructed of materials, which can operate effectively in extreme temperatures, without overt, limitations due to material degradation and/or unacceptable performance drift due to component aging. The pressure sensor assembly can be constructed of simple metal alloys or exotic ferromagnetic materials, depending on the desired tradeoffs of performance and cost. Pressure sensors according to embodiments herein may be constructed such that there will be little or no degradation of performance over time due to component aging or fatigue, which is a dramatic improvement over state of the art devises, which require sensitive electronic components to be located within the harsh environment.

While described above with respect to pressure measurement, a similar device may be designed and used in other industrial sensing applications, such as for the measurement of material displacement.

Sensor Array

The above-described temperature and pressure sensors may be used in a sensor array. For example, a sensor array according to embodiments herein may include two or more sensor modules, each including a sensor, such as a temperature or pressure sensor, having a solid core of ferromagnetic material associated with a wire coil forming a passive inductor resonant circuit. Each sensor in the array may be tuned such that its resonant frequency is in a bounded and unique frequency band, separate and not overlapping with a frequency band of another sensor module disposed in the array. The passive inductor resonant circuits may be tuned such that their resonant frequency is in a frequency band interrogable with an electromagnetic energy signal having a frequency of less than or equal to about 10 MHz. In embodiments herein, the passive inductor resonant circuit of the temperature or pressure sensors may be an un-doped passive inductor resonant circuit.

The sensor modules are connected in series via one or more transmission lines. The transmission lines, such as for transmitting an electrical excitation signal, and a transmission line for transmitting a response to the signal, may be formed from metallic cabling. Advantageously, such cabling may be used in harsh environments, including high temperature environments where fine electronics cannot be used, as well as vibratory and other environments unsuitable for use of fiber optic cabling.

Property Measurement System

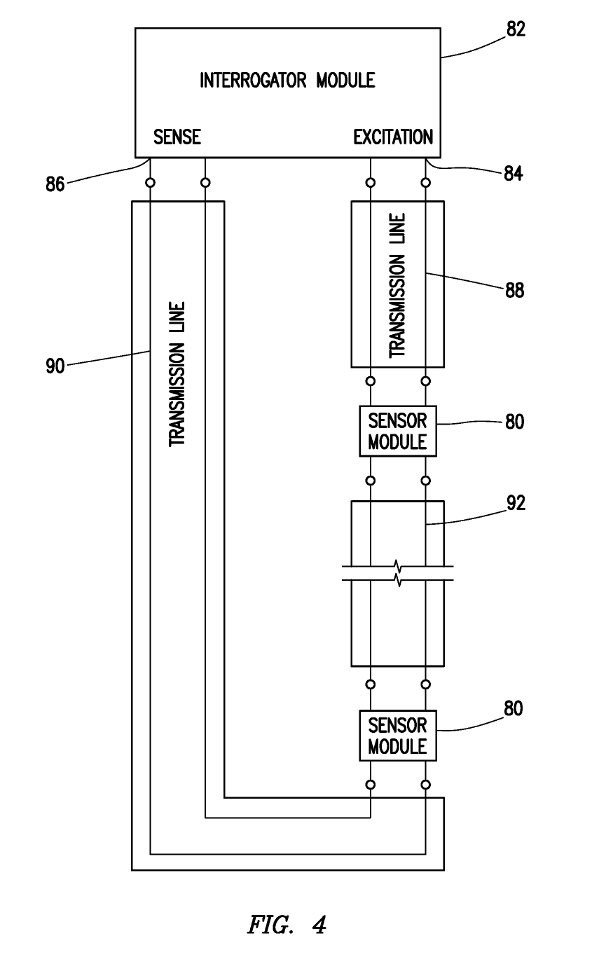

A simplified block diagram of a system for measuring properties of an environment, such as temperature and/or pressure of a wellbore, is illustrated, in FIG. 4. The system may include one or more sensor modules 80, and an interrogation module 82. The sensor modules 80, such as a temperature and/or pressure module as described above, may include a sensor having a solid core of ferromagnetic material associated with a wire coil forming a passive inductor resonant circuit. The interrogation module 82 may include an excitation port 84 and a sensor port 86. Excitation port 84 may be configured to provide electrical excitation, such as an electromagnetic energy signal, to the passive inductor resonant circuit of the sensor modules 80. Sensor port 86 may be configured to receive a transmitted response to the electrical excitation. The system may also include a transmission line 88 for transmitting the electrical excitation from the excitation port 84 to the passive inductor resonant circuits of the sensor modules 80, as well as a transmission line 90 for transmitting the response to the electrical excitation from the passive inductor resonant circuit of the sensor modules 80 to the sensor port 86.

The electrical excitation, provided by the excitation port may be at a frequency of less than or equal to about 10 MHz. As noted above with respect to the sensor array, the transmission line for transmitting the electrical excitation and the transmission line for transmitting the response may be formed from metallic cabling, thus negating the inherent flaws associated with fine electronics and fiber optics.

Measurement systems according to embodiments herein may include one or more sensor modules 80. As illustrated in the embodiment of FIG. 4, the system has two sensor modules 80. In other embodiments, the measurement system may include three, four, five, ten, twenty, or more sensor modules. Regardless of the number of sensor modules, the sensor modules may be connected in series via intermediate transmission lines 90.

The sensor modules may each be tuned such that they have a resonant frequency in a bounded and unique frequency band, separate and not overlapping with a frequency band of another sensor module disposed in the measurement system. In this manner, the interrogator module may provide electrical excitation that is bounded in frequency to a selected sensor module's frequency hand, and may demultiplex the responses received from the multiple sensor modules.

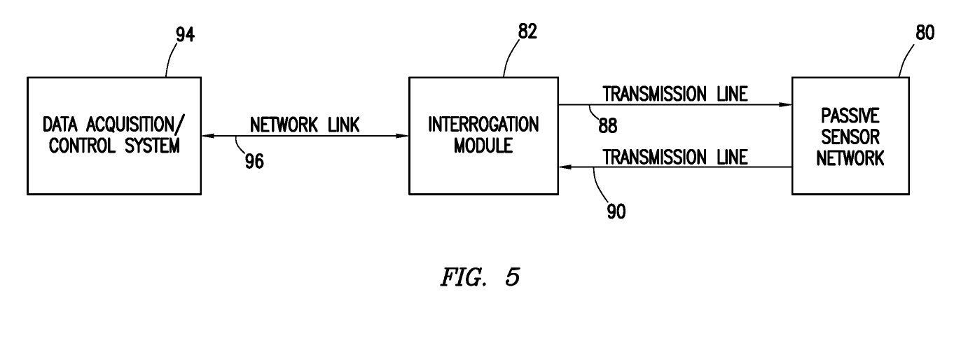

As illustrated in FIG. 5, measurement systems according to embodiments herein may also include a data acquisition and/or control system 94, which may be configured to communicate with the interrogation module, such as via a wired or wireless network ling 96. In this manner, the interrogation module may have the ability to exchange information with an external system using a network link.

To avoid the inherent fragility of passive optics and the temperature limitations imposed by active electronics, sensor array measurement systems described herein make use of passive circuit elements that are interrogated with low frequency electromagnetic energy. In this way, robust metallic cabling can be used instead of fragile fiber optics. Also, the materials used to fabricate the passive circuit elements do not have to include doped semiconductor materials, allowing passive circuit elements to operate at much higher temperatures than active electronics.

As described above, measurement systems according to embodiments herein may include three primary components: an interrogation module, transmission lines, and sensor modules.

The Interrogation Module:

The interrogation module is an apparatus that provides electrical excitation to the passive circuit elements within the sensor modules. In turn, the interrogation module will sense how the passive circuit elements respond to this electrical excitation. Sensor measurements will be derived from this response. Specifically, the transmitted response to excitation and not the reflected response is measured. For this reason, the interrogator has two ports: an Excitation Port and a Sense Port.

The network topology used to connect the interrogation module to the sensor modules is therefore a single bus that is driven and terminated by the excitation and sense ports of the interrogation module. Each sensor module is connected in series with this bus using discrete segments of transmission cable, such as illustrated in FIG. 4.

Furthermore, the interrogation module may execute a frequency sweep of the electrical excitation it provides. In this manner, the interrogation module may analyze the sensor modules response to varying frequencies of excitation. This also provides a mechanism to demultiplex the response of multiple sensor modules, which will be elaborated on in the “Sensor Modules” section bellow.

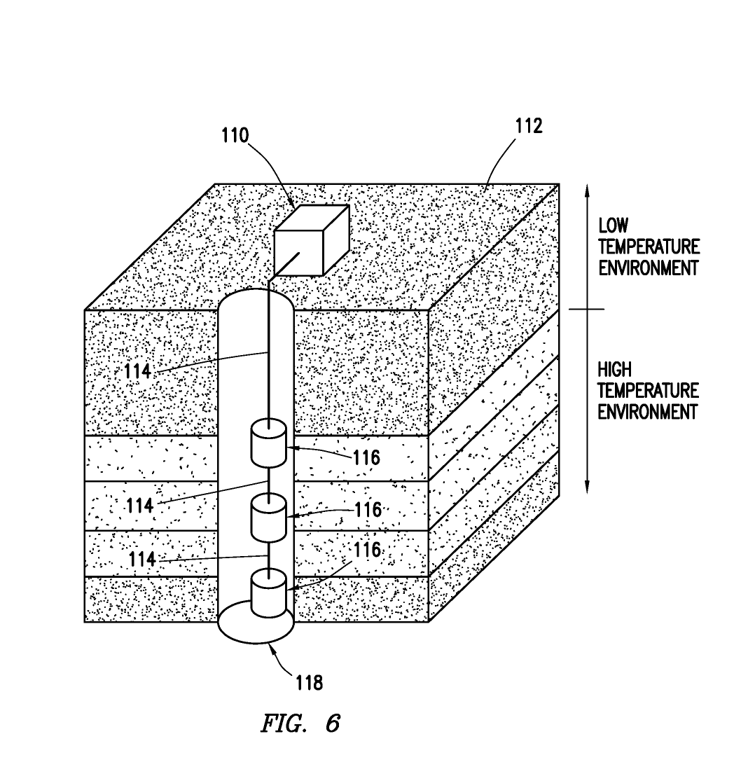

In some embodiments, the measurement system may be designed for oil and gas applications, such as to monitor the environment in high pressure, high temperature wells. As illustrated in FIG. 6, an interrogation module 110 may be placed at the surface 112, or other suitable locations, where pressure and temperature are low enough to be well tolerated by conventional electronics. Using transmission line segments 114, the sensor modules 116 may be placed inside a well 118, where environmental conditions are not favorable for active electronics. By separating the interrogation module, which is the only element of this system to contain active electronics, operators are free to expose the sensors modules to much higher temperatures and pressures.

Transmission Lines:

Transmission lines are used to connect the interrogation module to the passive sensor modules. Also, each passive sensor module is connected in series with segments of transmission line. Because the system operates at low frequencies, there is no requirement for the use of coaxial cable. Further, the use of transmission lines allows the interrogation module to be displaced from the high pressure and high temperature environments the sensor modules are intended to measure.

Sensor Modules:

Each sensor module contains a resonant passive circuit. Impedances within this passive circuit are designed to change with respect to environmental conditions, such as pressure and/or temperature, in doing so, the resonant frequency of the passive circuit will also change, thus environmental conditions can be derived from the resonant frequency of a passive sensor module. The resonant properties of this circuit will modulate the electrical excitation provided by the interrogation module in the frequency domain. This is the response that the interrogation module senses and the method by which data is collected from the sensor modules.

Another feature of the system is sensor module plurality that is implemented using frequency division multiplexing, or FDM. Each sensor module may be tuned such that its resonant frequency will lay in a bounded and unique frequency band, separate from and not overlapping with the frequency band of other sensor modules. This allows the interrogator module to demultiplex information from multiple sensor modules by providing electrical excitation that is hounded in frequency to a specific sensor module's frequency band.

Systems according to embodiments herein have several advantages over systems based on fiber optics. For example, systems described herein take advantage of phenomena that are related to electricity. Because of this, sensor elements can be interconnected via conductive metallic cabling which is not as fragile as fiber optic cabling. In relation to other solutions which are based on electricity, measurement systems according to embodiments herein may displace all active electronics from passive sensing elements at significant distances; may be no longer bound by the inherent environmental limitations of conventional active electronics, and provides that sensing elements can be deployed in environments with greater temperatures and pressures.

Furthermore, other solutions which are also capable of displacing active electronics from passive sensing elements at great distance utilize reflect based sensing schemes. Transmission lines in such systems have a less favorable frequency response as compared to the transmission based sensing scheme used by systems herein.

Methods of Use

As alluded to above, sensor systems and sensor array systems according to embodiments herein may be used for measuring a property, such as temperature and/or pressure in a wellbore. One method for measuring a wellbore property, such as pressure and/or temperature, according to embodiments herein may thus include a first step of disposing in a wellbore a sensor module or a sensor module array comprising at least one sensor comprising a solid core of ferromagnetic material associated with a wire coil forming a passive inductor resonant circuit. At least one sensor may then be interrogated with an electromagnetic energy signal having a frequency of less than or equal to about 10 MHz. A response from the sensor, such as a change in frequency of the electromagnetic energy signal may then be measured to determining a value of the measured property as a function of the change in frequency of the electromagnetic energy signal. The sensor module array may include two or more sensor modules connected in series via one or more transmission lines, which may each have a unique frequency band, the method also including demultiplexing the responses received from the two or more sensor modules.

As described above, embodiments herein provide sensors, sensor modules, sensor arrays, and measurement systems that are robust in construction. Sensors described herein include passive circuit elements that may be formed using metallic cabling. Sensors described herein may thus avoid the inherent fragility of passive optics and the temperature limitations imposed by active electronics, improving the reliability of the sensors, even, when used in a harsh environment, which may include high temperatures, high pressures, and contact with corrosive compounds.

While the disclosure includes a limited number of embodiments, those skilled in the art, having benefit of this disclosure, will appreciate that other embodiments may be devised which do not depart from the scope of the present disclosure. Accordingly, the scope should be limited only by the attached claims.

What is claimed:

1. A sensor module, comprising: a core of ferromagnetic material associated with a wire coil forming a passive inductor resonant circuit, wherein the passive inductor resonant circuit is tuned such that its resonant frequency is in a bounded frequency band interrogable with an electromagnetic energy signal having a frequency of less than or equal to about 10 MHz.

2. A temperature sensor module, comprising:
a housing;
a temperature sensor disposed within the housing and comprising a core of ferromagnetic material associated with a wire coil forming a passive inductor resonant circuit, an inductance of which varies with temperature; and
wherein the passive inductor resonant circuit is tuned such that its resonant frequency is in a bounded frequency band interrogable with an electromagnetic energy signal having a frequency of less than or equal to about 10 MHz.

3. The temperature sensor module of claim 2, wherein the inductance (L) of the passive inductor resonant circuit follows the equation:
$$L = \frac{{N}^{2} {μ}_{r} {μ}_{o} A}{{l}_{m}}$$
where
N=number of turns of the coil of wire,
A=cross sectional area of the ferromagnetic core material,
lₘ=mean magnetic path length through the core,
μᵣ=relative permeability of the ferromagnetic core material, and
μₒ permeability of free space;
wherein each of A, lₘ, and μᵣ vary as a function of temperature.

4. The temperature sensor module of claim 2, wherein the core of ferromagnetic material comprises a ferromagnetic material having a closed-core geometry with a gap perpendicular to the magnetic flux path, and the wire coil is disposed around at least a portion of the core.

5. The temperature sensor module of claim 4, wherein the inductance (L) of the passive inductor resonant circuit follows the equation:
$$L = \frac{{N}^{2} A}{\frac{{l}_{m}}{{μ}_{r 1} {μ}_{o}} + \frac{{l}_{g}}{{μ}_{r 2} {μ}_{o}}}$$
where
N=number of turns of the coil of wire,
A=cross sectional area of the ferromagnetic core material,
lₘ=mean magnetic path length through the core,
μᵣ₁=relative permeability of the ferromagnetic core material,
μₒ=permeability of free space,
l_{g}=length of the gap, and
μᵣ₂=relative permeability of material in the gap;
wherein each of A, lₘ, l_{g}, and μᵣ₁ vary as a function of temperature.

6. The temperature sensor module of claim 5, wherein the inductance of the passive inductor resonant circuit is primarily a function of a length of the gap.

7. The temperature sensor module of claim 5, wherein a ratio of μᵣ₂ to μᵣ₁ is at least 50:1.

8. The temperature sensor module of claim 2, wherein the temperature sensor is configured to measure a temperature range, the range having a maximum temperature below a Curie temperature of the core and the range inclusive of a temperature of at least 220° C.

9. A pressure sensor module, comprising:
a core, including a fixed core portion and a deflectable core portion, comprising a ferromagnetic material associated with a wire coil forming a passive inductor resonant circuit;
a gap between at least a portion of the fixed core portion and an internal surface of the deflectable core portion;
wherein a pressure applied to an outer surface of the deflectable core portion deflects the deflectable core portion, decreasing a length of the gap and affecting an inductance of the resonant circuit.

10. The pressure sensor module of claim 9, wherein the passive inductor resonant circuit is timed such that its resonant frequency is in a bounded frequency hand interrogable with an electromagnetic energy signal having a frequency of less than or equal to about 10 MHz.

11. The pressure sensor module of claim 9, wherein the inductance (L) of the passive inductor resonant circuit follows the equation:
$$L = \frac{{N}^{2} A}{\frac{{l}_{m}}{{μ}_{r 1} {μ}_{o}} + \frac{{l}_{g}}{{μ}_{r 2} {μ}_{o}}}$$
where
N=number of turns of the coil of wire,
A=cross sectional area of the ferromagnetic core material,
lₘ=mean magnetic path length through the core,
μᵣ₁=relative permeability of the ferromagnetic core material,
μₒ=permeability of free space,
l_{g}=length of the gap, and
μᵣ₂=relative permeability of material in the gap.

12. The pressure sensor module of claim 11, wherein the inductance of the passive inductor resonant circuit is primarily a function of a length of the gap.

13. The pressure sensor module of claim 12, wherein a ratio of μᵣ₂ to μᵣ₁ is at least 50:1.

14. The pressure sensor module of claim 9, wherein the pressure sensor is configured to measure a pressure range when operating at a temperature below a Curie temperature of the core and inclusive of operating temperatures of at least 220° C.

15. The pressure sensor module of claim 9, wherein the pressure sensor is configured to measure a pressure range, wherein the range is inclusive of pressures greater than 100 psig.

16. The pressure sensor module of claim 9, wherein the deflectable core portion comprises an outer surface material suitable for use in corrosive environments.

17. A sensor array, comprising:
two or more sensor modules comprising a sensor comprising a solid core of ferromagnetic material associated with a wire coil forming a passive inductor resonant circuit;
wherein each sensor in the array is tuned such that its resonant frequency is in a bounded and unique frequency band, separate and not overlapping with a frequency band of another sensor module disposed in the array.

18. The sensor array of claim 17, wherein the sensor modules are connected in series via one or more transmission lines.

19. The sensor array of claim 17, wherein the passive inductor resonant circuits are tuned such that their resonant frequency is in a frequency band interrogable with an electromagnetic energy signal having a frequency of less than or equal to about 10 MHz.

20. The sensor array of claim 19, further comprising a transmission line for transmitting the electromagnetic energy signal and a transmission line for transmitting the response m the sensor modules, wherein the transmission lines comprise metallic cabling.

21. The sensor array of claim 20, wherein the sensors and the transmission cables are configured to operate at temperatures of greater than 220° C.

22. The sensor array of claim 20, wherein the sensors are configured to operate at pressures greater than 100 psig.

23. The sensor array of claim 17, wherein the passive inductor resonant circuit is an un-doped passive inductor resonant circuit.

24. The sensor array of claim 17, wherein the sensor comprises at least one of a temperature sensor and a pressure sensor.

25. A system for measuring properties of a wellbore, such as temperature and/or pressure, the system comprising:
a sensor module comprising a sensor comprising a solid core of ferromagnetic material associated with a wire coil forming a passive inductor resonant circuit;
an interrogation module comprising:
an excitation port configured to provide electrical excitation to the passive inductor resonant circuit; and
a sensor port configured to receive a transmitted response to the electrical excitation;
a transmission line for transmitting the electrical excitation from the excitation port to the passive inductor resonant circuit; and
a transmission line for transmitting the response to the electrical excitation from the passive inductor resonant circuit to the sensor port.

26. The system of claim 25, wherein the electrical excitation provided by the excitation port is at a frequency of less than or equal to about 10 MHz.

27. The system of claim 25, wherein the transmission fine for transmitting the electrical excitation and the transmission line for transmitting the response comprise metallic cabling.

28. The system of claim 25, wherein the passive inductor resonant circuit is an on-doped passive inductor resonant circuit.

29. The system of claim 25, wherein the sensor module and transmission lines are configured to operate at temperatures of at least 220° C.

30. The system of claim 25, further comprising one or more additional sensor modules.

31. The system of claim 30, wherein the sensor module and the one or more additional sensor modules are connected in series via one or more additional transmission lines.

32. The system of claim 30, wherein the sensor module and the one or more additional sensor modules are each tuned such that its resonant frequency is in a bounded and unique frequency band, separate and not overlapping with a frequency band of another sensor module disposed in the system.

33. The system of claim 32, wherein the interrogator module is configured to:
provide electrical excitation which is hounded in frequency to a selected sensor module s frequency band; and
demultiplex the responses received from the multiple sensor modules.

34. The system of claim 25, further comprising a data acquisition and control system configured to communicate with the interrogation module.

35. The system of claim 25, wherein the sensor module comprises a temperature sensor configured to measure temperature range inclusive of a temperature of at least 220° C.

36. The system of claim 25, wherein the sensor module comprises a pressure sensor configured to measure pressure in a range of pressure exceeding 100 psig while exposed to a temperature of at least 220° C.

37. A process for measuring a property in a wellbore, comprising:
disposing in a wellbore a sensor module or a sensor module array comprising at least one sensor comprising a solid core of ferromagnetic material associated with a wire coil forming a passive inductor resonant circuit;
interrogating the at least one sensor with an electromagnetic energy signal having a frequency of less than or equal to about 10 MHz;
measuring a response from the sensor comprising a change in frequency of the electromagnetic energy signal; and
determining a value of the measured property as a function of the change in frequency of the electromagnetic energy signal.

38. The process of claim 37, wherein the sensor module array comprises two or more sensor modules connected in series via one or more transmission lines.

39. The process of claim 38, further comprising demultiplexing the responses received from the two or more sensor modules.
